(19) United States
(12) Patent Application Publication
(10) Pub. No.: US 2013/0296747 A1
(43) Pub. Date: Nov. 7, 2013

(54) RFID-BASED DETERMINATION OF COMPRESSION AND MOTION DURING CPR CHEST COMPRESSION

(71) Applicant: PHYSIO-BLAZER, Redmond, WA (US)

(72) Inventors: Daniel Conan Perreault, Everett, WA (US); Isabelle Banville, Newcastle, WA (US); Gregory T. Kavounas, Bellevue, WA (US); Robert P. Marx, Jr., Kent, WA (US)

(73) Assignee: PHYSIO-CONTROL, INC., Redmond, WA (US)

(21) Appl. No.: 13/887,275

(22) Filed: May 3, 2013

Related U.S. Application Data
(60) Provisional application No. 61/642,420, filed on May 3, 2012.

(51) Int. Cl. A61H 31/00

(52) U.S. Cl. CPC A61H 31/005
USPC 601/41

(57) ABSTRACT

During cardiopulmonary resuscitation (CPR), compressions are delivered to a patient. The CPR compression includes a depth of compression. A medical device uses radio frequency identification (RFID) technology to determine the depth of compression.

### RELATED APPLICATION

This application is related to and claims the benefit of priority of U.S. Provisional Patent Application Ser. No. 61/642,420, filed on May 3, 2012, the disclosure of which is incorporated by reference herein.

### BACKGROUND

In certain types of medical emergencies, Cardiopulmonary Resuscitation (CPR) needs to be delivered to a patient. CPR includes repeatedly compressing the chest of the patient, to cause their blood to circulate some. CPR also includes delivering rescue breaths to the patient. A number of people are trained in CPR, just in case, even though they are not trained in the medical professions.

The chest compressions are intended to cause the blood to continue circulating, so as to prevent damage to organs like the brain. In some instances, the chest compressions merely maintain the patient, until a more definite therapy is made available, such as defibrillation. Defibrillation is an electrical shock deliberately delivered to a person, in the hope of correcting their heart rhythm.

A problem is that CPR is sometimes ineffective at providing blood circulation to the patient. That can happen whether or not the rescuer who performs the CPR is part of the medical profession. The most frequent example of such ineffectiveness is compressions that are not deep enough, or not frequent enough, or do not last long enough. Even the best trained rescuers can become fatigued after delivering CPR, with the compressions deteriorating in quality. And that is without even accounting for the emotions of the moment, which might impact a lay rescuer.

The risk of ineffective chest compressions has been addressed with CPR feedback devices, some of which are standalone, while others are integrated or cooperate with defibrillators. These devices actually detect the depthand frequency of compressions that the rescuer is performing, and give feedback to the rescuer that is specifically attuned to what the rescuer is doing. This feedback is in accordance with how well the rescuer is meeting guidelines, such as those of the American Heart Association. These prompts and other instructions and can help the rescuer focus, even if the latter cannot remember their training.

Reaching the appropriate depth is difficult. The recommended depth is a range. If the actual depth is less than the range, not enough blood is moved within the patient. If the depth exceeds the range, the patient's ribs may break. And, even for experienced rescuers, it is sometimes hard to discern the appropriate depth. Reaching the appropriate depth is even more difficult if the patient is on a flexible mattress that partly recedes, as the rescuer is pushing from the top. And CPR compressions can be even more challenging if the rescuer has to deliver them in a moving ambulance.

The risk of ineffective chest compressions has been moreover addressed with CPR chest compression machines. Such machines have been known by a number of names, such as mechanical CPR devices, cardiac compressors, external chest compression machines, and so on. One such machine is the LUCAS® made by Physio-Control, Inc.

CPR chest compression machines repeatedly compress and release the chest of the patient. Such machines can be programmed so that they will compress and release at the recommended rate, and always reach a specific depth within the recommended range.

CPR chest compressions should be performed correctly. When CPR is given manually, it is difficult to do it correctly. When CPR is given by automated machines there are challenges, if patients of different sizes could be expected.

Shifting and sliding can be caused by the patient and/or compression structure being moved up or down stairs, for example. If the person slides in the CPR chest compression machine, then the piston of the CPR chest compression structure will not make contact with the person at the center of the person's chest. It is sometimes advised to not operate, or operate with caution, the CPR chest compression machine, during periods of time when the person and/or CPR chest compression structure are tilted more than a critical value. Such limitations may be difficult to remember, or may be disregarded, during actual resuscitation use of the CPR chest compression machine, to the possible detriment of the effectiveness of the chest compressions being provided.

### BRIEF SUMMARY

The present description gives instances of medical technology that helps overcome problems and limitations of the conventional approaches.

In one embodiment, a medical device that facilitates delivery of cardiopulmonary resuscitation (CPR) compressions to a patient. The medical device includes a radio frequency identification (RFID) tag, an RFID antenna, and an RFID reader. One of the RFID tag or the RFID antenna being configured to be in a fixed spatial relation with one of a front point that corresponds to a chest of the patient or a back point that corresponds to a back of the patient. The other of the RFID tag or RFID antenna is configured to be in a fixed spatial relation with the other of the RFID tag or the RFID antenna. The RFID reader is designed to drive the antenna to repeatedly transmit a query signal to the RFID tag. The RFID antenna being further designed to receive a response signal from the RFID tag. The RFID reader being further configured to infer an occurrence, a depth, rate, duty cycle, time profile, and frequency of compression of a CPR compression between the front point and the back point based upon the response signal. The time profile may also indicate shivering, shaking, or vibrations of the patient, like in a moving vehicle.

### BRIEF DESCRIPTION OF THE DRAWINGS

FIG. 1 illustrates a Cardiopulmonary Resuscitation (CPR) chest compression scenario in which a standalone medical device may be employed in accordance with the technology described herein. The RFID antenna or RFID tag on the chest could be part of an assembly like a top portion that sits on the chest or it could be part of a glove that the rescuer wears. Alternatively it can be an adhesive tag or an epidermal electronic stick-on or temporary tattoo, as there could be many embodiments.

FIG. 2 is a diagram of an abstracted compression structure of a Cardiopulmonary Resuscitation (CPR) chest compression structure used to save the life of a person in accordance with the technology described herein.

FIG. 3 is a flowchart for illustrating methods according to embodiments.

FIG. 4 is a diagram for geometric considerations, showing only a top point and a back point on a backboard according to embodiments.

FIG. 5 is a diagram showing a possible embodiment of how depth compression might be determined for the arrangement of FIG. 4.

FIG. 6 is a diagram showing another possible embodiment of how depth compression might be determined for the arrangement of FIG. 4.

FIG. 7 is a diagram of a possible constellation of RFID tags in the pattern of a square lattice according to a sample embodiment.

### DETAILED DESCRIPTION

The technology described herein is related to Cardiopulmonary Resuscitation (CPR) chest compression technologies. In particular, the technology described herein is related to the use of radio frequency identification (RFID) technology to assist CPR chest compressions. Embodiments are now described in more detail.

CPR Compression Scene with Example Medical Device

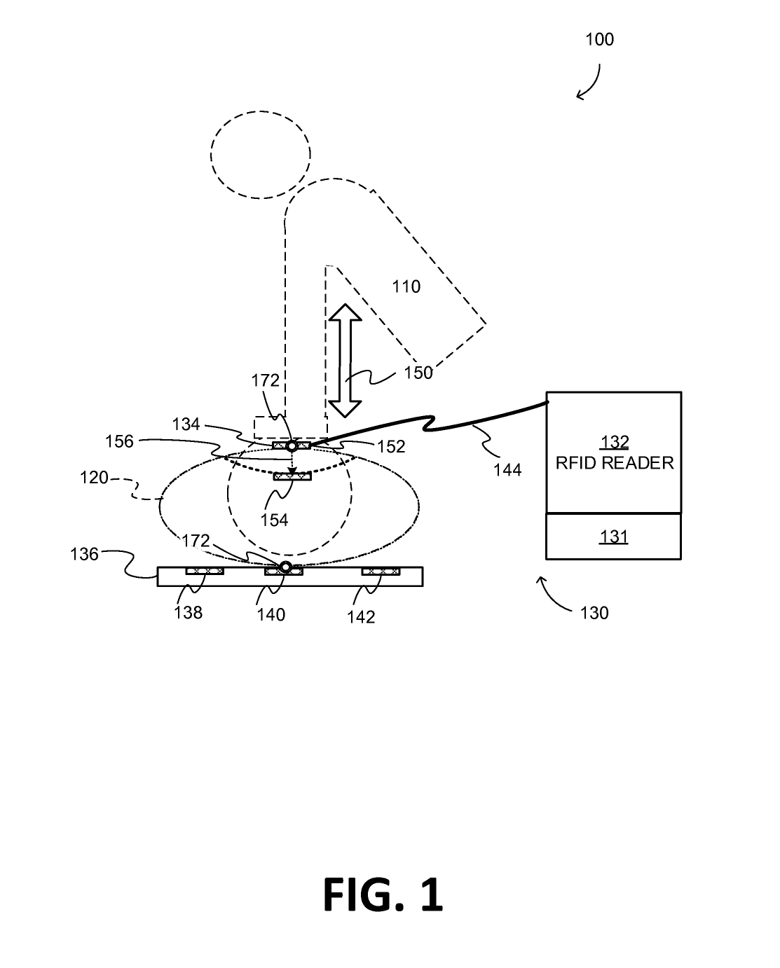

FIG. 1 shows a CPR scene 100 with a rescuer 110 resuscitating a patient 120 using CPR chest compressions. The scene 100 also includes a standalone medical device 130 that is designed to assist with CPR chest compression resuscitation. The medical device 130 includes a RFID reader 132, a RFID antenna 134, and backboard 136 with multiple RFID tags, which include tag 138, tag 140, and tag 142. Alternately, these tags may be attached to the patient's body, such as in the back.

The medical device 130 includes an output unit 131. The RFID reader 132 is connected to the RFID antenna 134 via wires 144. Alternatively, these components maybe connected wirelessly.

RFID is a technology that uses small radio frequency (RF) identification devices (i.e., RFID tags), a read/write device (RFID reader), and a host system application for data collection, processing, and transmission. The RFID tag is a transponder that includes an integrated circuit (e.g., a chip), some memory, and an antenna. The RFID reader also typically includes an RFID antenna.

With the example medical device 130, the RFID technology determines the depth of a CPR compression based, at least in part, upon two known points. One known point is relative to the patient's chest and another known point is relative the patient's back. These points are illustrated in FIG. 1 as front point 170 and back point 172. More particularly, the RFID tag and/or the antenna is designed to be in a fixed spatial relation with the front point and/or the back point while the other of the tag or the antenna is designed to be in a fixed spatial relation with the other of the tag or the antenna.

The RFID antenna 134 will transmit wireless query signals that are fed to it by wire 144 from reader 132. The wireless query signals will be received by constellation of RFID tags 138, 140, 142, which are in backboard 136. The same antenna 134 will receive the wireless responses, which are also known as backscatter, from the tags 138, 140, 142, and transmit to the reader 132. Reader 132 will then interpret backscatter to determine a single measure of distance from the back point 172 to the closest of tags, which it will determine to be tag 140, in this instance.

During CPR, the patient 120 is placed on the backboard 136 and the antenna 134 is placed onto or in very close proximity to the patient's chest. Often, the antenna has an adhesive for temporary attachment to the patient's chest. In this situation, the antenna 134 defines the front point 170 that corresponds to the patient's chest. Similarly, the backboard defines the back point 172 that corresponds to the back of the patient 120.

With his hand to the chest of the patient 120, the rescuer 110 pumps the patient's chest. The up and down motion of the compression and releases is represented by double-headed arrow 150. Note that the arrow 150 indicates that the compressions are in the center of the patient's chest.

When compressions 150 are performed on the patient 120, the RFID antenna 134 on the patient's chest moves from a first position 152 to a position 154. Arrow 156 indicates the direction of the chest compression and the depth of compression. The depth of compression is the distance that the RFID antenna 134 travels when it moves from position 152 to position 154 can be correlated to a depth of compression. The indications may be provided to the rescuer real-time or collected to allow the rescuer to review them later.

According to the 2010 CPR Guidelines from the American Heart Association, the desired for depth of compression for a typical adult is at least two inches. For a typical child, it is at least a third of the depth of the chest. Of course, the exact right distance depends upon the chest cavity size of the actual patient.

The RFID reader 132 is coupled to the RFID antenna 134. The RFID antenna 134 transmits a query signal to the RFID tags of the backboard 136. The RFID antenna 134 receives a response signal from the RFID tags of the backboard 136.

Based at least in part on the query signal and response signal, the RFID reader 132 determines the depth of compression of the compressions 150 during delivery of the CPR chest compression.

The output unit 131 may communicate a recommended additional CPR chest compression and that such compression be done at a different depth.

Integrating the constellation of RFID tags 138, 140, and 142 in the backboard 136 allows a fixed reference for inferring the position of the top of the chest during CPR. While not necessary, the constellation of RFID tags 138, 140, and 142 in some embodiments is further placed in the backboard 136 in a spatially repeating pattern.

In the illustrated embodiment, the constellation of RFID tags 138, 140, and 142 is two-dimensional. Alternatively, the constellation may have one or three dimensions of tags. While the constellation depicted in FIG. 1 has three RFID tags, alternative implementations may use one or more RFID tags.

Each tag in the constellation of RFID tags 138, 140, and 142 can be encoded with its location relative to the backboard 136 or equivalent portion of the backboard 136, and also as to its location relative to the other RFID tags 138, 140, and 142 in the constellation.

Determination can be by a suitable mathematical operation, such as triangulation. This procedure can be done at a high sample rate as to track the motion of the reader through space as compressions are being performed.

The RFID reader 132 determines the depth of CPR chest compression during delivery of the CPR chest compression. Based on query signals to the constellation of RFID tags 138, 140, and 142, and reflected response signals from the constellation of RFID tags 138, 140, and 142, the RFID readers 132 determines the distance from the RFID antenna 134 from a selected back point, and optionally also to each RFID tag in the constellation of RFID tags 138, 140, and 142. In one or more implementations, one RFID tag in the constellation 138, 140, and/or 142 can carry reading instructions and/or passwords for the other RFID tags in the constellation. The passwords can be known by any one or all of the RFID tags in the constellation 138, 140, and/or 142. The RFID tags in the constellation 138, 140, and/or 142 can communicate with each other using the password(s).

In one or more implementations, the disclosed RFID technology determines the depth of a CPR compression delivered by the compression structure 140. For example, in embodiments a system for detecting chest compressions includes an RFID tag that is positioned near the patient's chest, an RFID reader, and an RFID antenna. The RFID reader causes a signal to be sent to the RFID tag, causing the RFID tag to backscatter. The RFID reader collects the backscattered signal and, from it, detects the distance many times per second to detect the motion of the RFID tag during chest compression.

In one or more implementations, RFID technology determines the depth of a CPR compression based, at least in part, upon two known points. One known point is relative to the patient's chest and another known point is relative the patient's back. These points are illustrated in FIG. 1 as front point 170 and back point 172. More particularly, the RFID tag and/or the antenna is designed to be in a fixed spatial relation with the front point and/or the back point while the other of the tag or the antenna is designed to be in a fixed spatial relation with the other of the tag and the antenna.

Example Medical Device used with a CPR Compression Structure

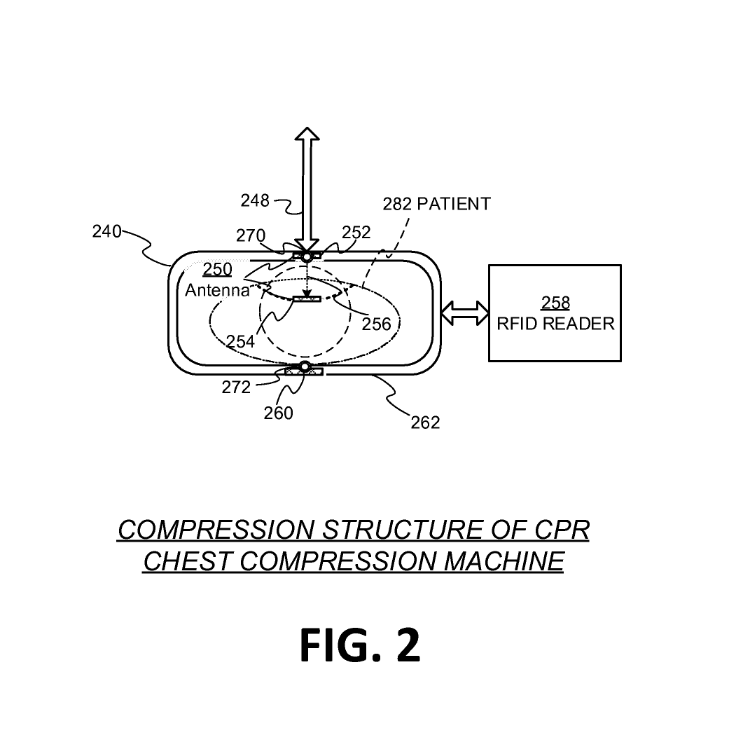

FIG. 2 is a diagram of an abstracted compression structure 240 of a CPR chest compression structure according to the technology described herein. A patient 282 is placed within compression structure 240. Then compression structure 240 repeatedly compresses and releases their chest. These compressions and releases are designated by arrow 248, regardless of how effectuated. Note that the arrow 248 indicates that the compressions are in the center of the patient's chest.

Compression structure 240 is shown as reaching around the chest of patient 282. This alleviates a problem of the patient being on a flexible mattress, which causes ineffective CPR. Indeed, compressions 248 are with respect to compression structure 240, not the mattress. But structure 240 typically does not cover, for example, the head of patient 282.

Compression structure 240 is abstracted, in that it may be implemented in any number of ways. In some embodiments, a belt squeezes and releases the patient's chest.

The compression structure 240 utilizes the disclosed RFID technology to determine a depth of compression for CPR chest compressions. In one or more implementations, RFID technology determines the depth of a CPR compression delivered by the compression structure 240. For example, a system for determining the depth of chest compressions includes an RFID antenna 250 that is positioned near the patient's chest, an RFID reader 258, and a constellation 260 of one or more RFID tags fixed into part of a backboard 262. The RFID reader 258 transmits a signal to the RFID tags of the constellation 260, causing the RFID tags to reflect the signal back into the direction of the RFID antenna 250. The RFID reader 258 collects the reflected signal and, from it, detects the distance many times per second to detect the motion of the RFID antenna 250 (relative to the constellation) during chest compression.

In one or more implementations, RFID technology determines the depth of a CPR compression based, at least in part, upon two known points. One known point is relative to the patient's chest and another known point is relative the patient's back. These points are illustrated in FIG. 2 as front point 270 and back point 272. More particularly, the RFID tag and/or the antenna is designed to be in a fixed spatial relation with the front point and/or the back point while the other of the tag or the antenna is designed to be in a fixed spatial relation with the other of the tag and the antenna.

To illustrate, the compression structure 240 includes the RFID antenna 250, which is in proximity to the chest of the patient 282. In one or more implementations, the RFID antenna 250 is adhered to the chest of the patient 282.

In FIG. 2, there is an exaggerated gap between the patient's chest and the top of the compression structure 240. In reality and in other implementations, there may be little to no gap.

The compression structure 240 is coupled to RFID reader 258. In this way, the RFID reader 258 is coupled to the RFID antenna 250 and the constellation 260. The RFID antenna 250 transmits a query signal from the RFID reader 258 to the RFID tags of the constellation 260. The RFID antenna 250 receives response signals from the tags.

When compressions 248 are performed on the patient 282, the RFID antenna 250 moves from a position 252 to a position 254. The distance that the RFID antenna 250 travels when it moves from position 252 to position 254 is correlated to a depth of compression.

Based at least in part on the query signal and response signal, the RFID reader 258 can determine the depth of the compressions 248 during delivery of the CPR chest compression.

In one or more implementations, the RFID antenna 250 is disposable or reusable. Alternatively, the RFID antenna 250 can be encapsulated into extremely durable reusable configurations.

In one or more implementations, the RFID tags include unique the RFID tag information. In one or more implementations, the RFID tag includes the location of the RFID tag relative to the other tags.

Information on the RFID tags can be encrypted. For example, killing and/or rewriting RFID tag can be prevented by suitable programming.

### Example Methods

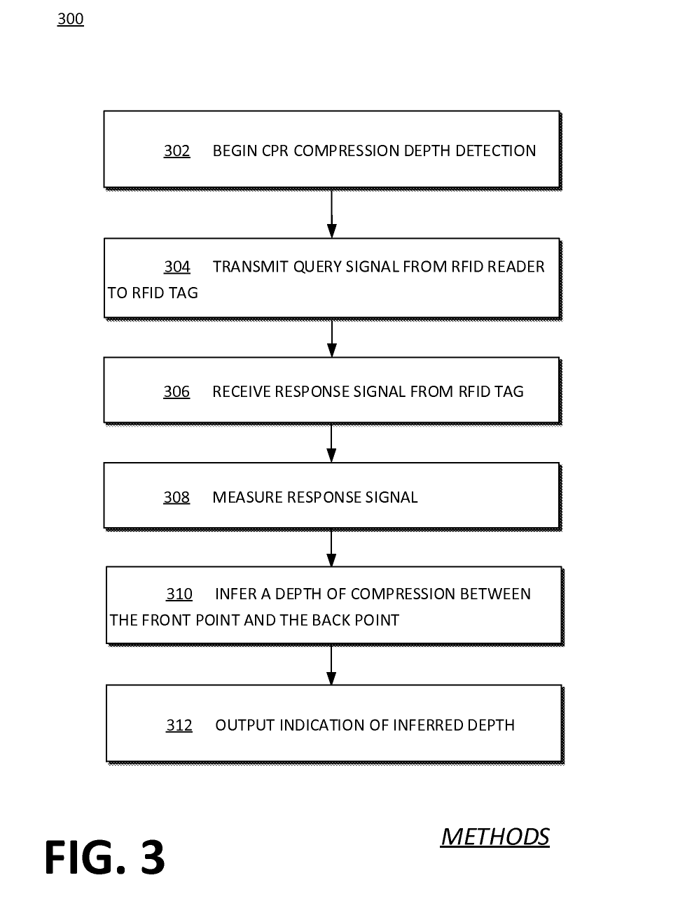

FIG. 3 shows a flowchart 300 for describing methods according to embodiments, for assisting with a CPR chest compression structure to deliver CPR compressions to a patient. The method of flowchart 300 may also be practiced by CPR chest compression machines or by a standalone device. For instance, the external CPR chest compressor includes an RFID reader, which is coupled to an RFID antenna, and an RFID tag. The RFID tag is in proximity to the patient's chest. The CPR chest compression includes a first depth of compression.

According to an operation 302, a CPR chest compression occurs. It occurs between a front point that corresponds to a chest of the patient and a back point that corresponds to a back of the patient.

According to an operation 304, the RFID reader a query signal to a RFID tag. The RFID tag is in a fixed spatial relation with one of the front point or the back point.

An operation 306 receives a reflected response signal from the RFID tag.

An operation 308 measures the reflected response signal.

An operation 310, based at least in part upon the measured response signal to the query signal, infers a depth of compression between the front point and the back point.

An operation 312 outputs an indication of the inferred depth of compression. The indication can be used by a rescuer so as to adjust how deeply they are compression the patient's chest.

For flowchart 300, it will be recognized that a number of their operations can be augmented with what was described above.

Geometric and other considerations are now provided.

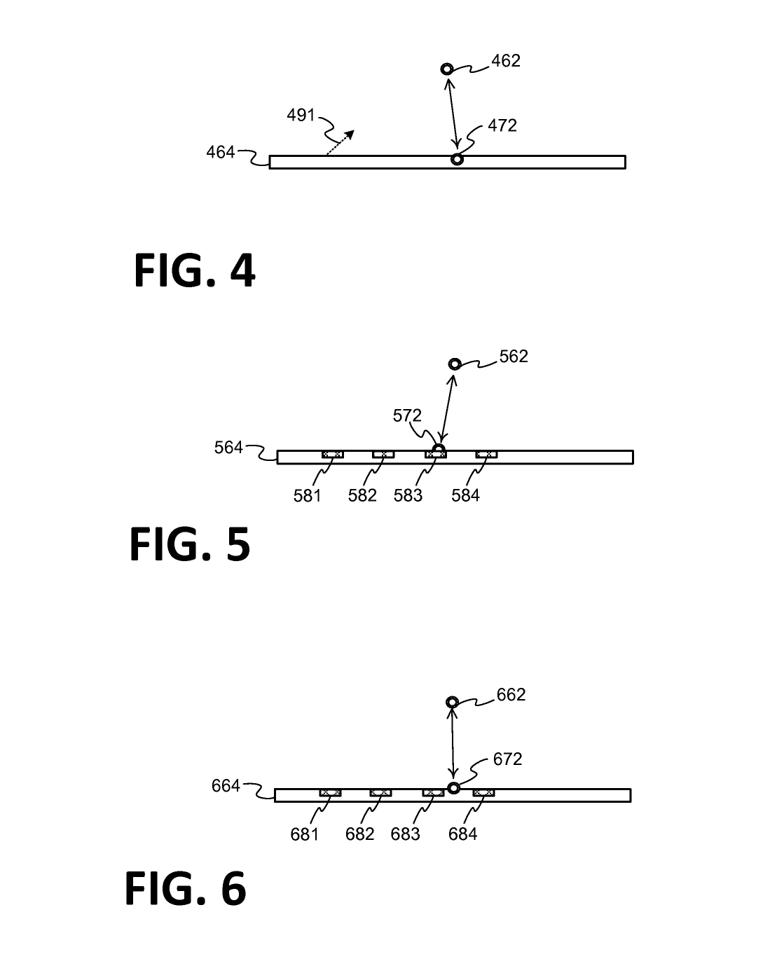

FIG. 4 is a diagram for geometric considerations, showing only top point 462 and back point 472 on backboard 464 according to embodiments. The response signals are shown from a constellation of RFID tags on backboard 464. The RFID tags are not shown, but one of the response signals 491 is shown. In some embodiments, a distance is determined from the RFID antenna, which corresponds to top point 462, to a selected back point 472 in the constellation. The distance, shown by an arrow, may be treated as the compression depth, and or the compression depth may be found from it. The choice involves how point 472 is selected. Two examples are described.

FIG. 5 is a diagram showing a possible embodiment of how depth compression might be determined for the arrangement of FIG. 4. A top point 562 could be the same as point 462, and corresponds to the RFID antenna, considered as a point source. Backboard 564 has a constellation of tags 581, 582, 583, 584. In this embodiment, the selected back point 572 is tag 583, which is determined to be the closest to the antenna.

FIG. 6 is a diagram showing another possible embodiment of how depth compression might be determined for the arrangement of FIG. 4. A top point 662 could be the same as point 462, and corresponds to the RFID antenna, considered as a point source. Backboard 664 has a constellation of tags 681, 682, 683, 684. In this embodiment, the selected back point 672 does not correspond to a tag; rather, it is a point corresponding to substantially vertically derived footprint of the RFID antenna onto the backboard. Determining that may require triangulation, which is best performed if additional distances are known. One way to provide additional distances is by having the RFID tags be at known distances among themselves.

In some embodiments, therefore, at least some of the RFID tags in the constellation exhibit a regular, spatially periodic pattern, which can be called a lattice.

For many embodiments, the lattice is substantially two-dimensional, but that is not limiting as will be understood from the below. Two sample lattices are now described.

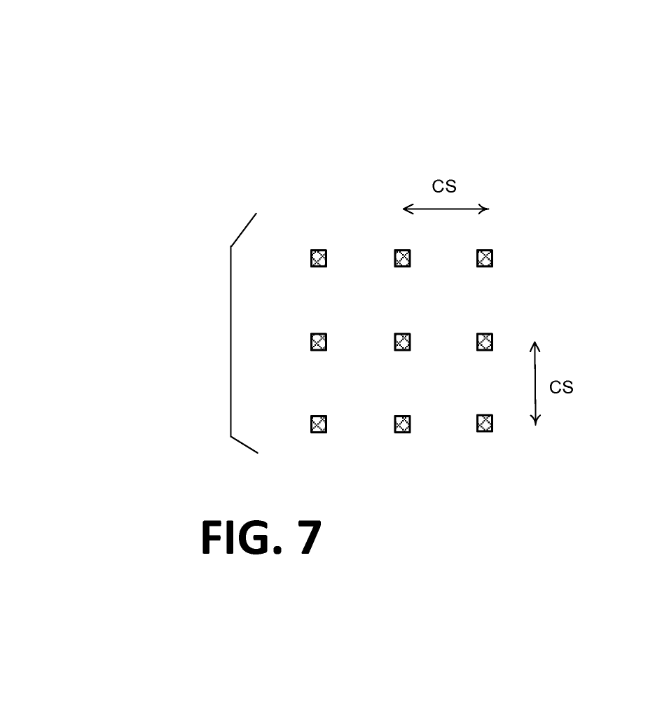

FIG. 7 is a diagram of a possible constellation of RFID tags in the pattern of a square lattice according to an embodiment. It will be understood that different lattices can also be drawn.

The advantage of arranging the constellation of RFID tags in a lattice is that it enables describing their positions relative to each other with very few parameters. For example, the lattice of FIG. 7 can be described as “square”, in that it is made of square “cells”, each with one RFID tag at each corner. Of that lattice, the only distance that needs to be known, also called cell spacing (CS), is that of the edge of one square, i.e. the minimum distance between the two tags. Another kind of lattice can be with tags at the corners of equilateral triangles. Again, only one cell spacing distance will be needed, that of a side of the triangle.

Given the pattern of a lattice, computations are enabled for the compression depth that can take place regardless of the exact location of the top portion's footprint on the lattice. In other words, it may not have to be necessary to align a specific point of a backplate that has the RFID tags to be exactly under the top portion that has the antenna, for measuring the compression depth substantially accurately.

A good “surface density” of RFID tags in the constellation can be found by opposing considerations. On the one hand, the closer the tags are to each other, more readings will be provided, and the depth determination will have higher confidence. In addition, it will be more likely that one of them will be substantially underneath the top portion, and its value can be used without the need for triangulation, or even the need for the tags to be in a lattice pattern. On the other hand, the closer the tags are to each other, the less they will behave as point sources, which may affect the accuracy of the computation. Moreover, when too close they may start shielding each other, which will not necessarily enable the RFID reader to transition to lower power.

If the constellation is provided in the form of a lattice, then the density can be quantified also using the value of the cell spacing CS.

If the tags are part of a lattice, the backscatter could communicate the shape of the lattice and the cell spacing (CS) of the unit cell. In addition, the EPCs could also communicate coordinate-type information within the lattice. For example, in a square lattice, each tag could also backscatter its row and column information.

In other words, at least two of the RFID tags are configured to backscatter respective coordinates within the pattern. Then, in subsequent reads, the reader can select only a few tags of the constellation, to further hone in for making the right depth determination. Preferably, the tags have Electronic Product Codes (EPCs), on which the reader can select. The tags could have passwords for being read. If they do, the reader should know the passwords in advance, or should be able to determine after a handshake. Planning that will have to be coordinated with the decision of how well the reader should be planned to work with these particular tags, namely whether the same top portion is always expected to work with the same bottom portion, and so on.

The reader is able to determine the distances of the antenna from each tag, at least relative to each other. The reader can decide which measurements to discard. Then it can determine the right compression depth by triangulation, or other approximation, plus optionally the knowledge of the cell spacing. If tags are used at high frequency, such as UHF, then multiple reads will be enabled per second, providing more accurate answers. Such tags include also the smarts for including passwords, coordinates, cell spacing, and so on. While passive tags have been described, active tags can also be used.

While measuring distance with RFID statically is difficult, various embodiments of the invention use one or more of the facts that a) the chest is often being moved by CPR, b) there is more than one tag to measure from, and c) a reference distance can be used, such as the cell spacing. As such, embodiments of the invention operate differently from what is described in U.S. Pat. No. 7,714,773.

The reader preferably is pre-associated with the tags. In other words, either it will know in advance their EPCs, or certain parameters of their EPCs for reliable identification. Another aspect of identification will be that the reader will need to operate at low power.

The reader may identify other RFID tags in the vicinity, but can ignore them in a number of ways, such as by judicious use of the Select command in certain instances. Or it can read & interpret them, for example if they would affect changing environmental conditions. For example, defibrillation or ECG electrodes could be separately provided with RFID tags, which will be read by the reader.

### Notes and Additional/Alternative Implementation Details

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventor does not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “computer-readable media” includes computer-storage media. For example, computer-storage media may include, but are not limited to, magnetic storage devices (e.g., hard disk, floppy disk, and magnetic strips), optical disks (e.g., compact disk [CD] and digital versatile disk [DVD]), smart cards, flash memory devices (e.g., thumb drive, stick, key drive, and SD cards), and volatile and nonvolatile memory (e.g., RAM and ROM).

In the claims appended herein, the inventor invokes 35 U.S.C. §112, paragraph 6 only when the words “means for” or “steps for” are used in the claim. If such words are not used in a claim, then the inventor does not intend for the claim to be construed to cover the corresponding structure, material, or acts described herein (and equivalents thereof) in accordance with 35 U.S.C. §112, paragraph 6.

What is claimed is:

1. A medical device that assists with providing feedback for the delivery of cardiopulmonary resuscitation (CPR) compressions to a patient, the medical device comprising:
a radio frequency identification (RFID) tag;
an RFID antenna,
one of the RFID tag or the RFID antenna being configured to be in a fixed spatial relation with one of a front point that corresponds to a chest of the patient or a back point that corresponds to a back of the patient, and the other of the RFID tag or RFID antenna is configured to be in a fixed spatial relation with the other of the RFID tag or the RFID antenna; and
a RFID reader that is configured to drive the antenna to repeatedly transmit a query signal to the RFID tag,
in which the RFID antenna is further configured to receive a response signal from the RFID tag and the RFID reader is further configured to infer a depth of compression of a CPR compression between the front point and the back point based upon the response signal;
an output unit configured to communicate the inferred depth at any moment in time of compression of the CPR compression.

2. A medical device in accordance with claim 1, further comprising:
a backboard configured to be placed under the back of the patient, the backboard including the RFID tag as part of a constellation of RFID tags, wherein one RFID tag in the constellation is a reference RFID tag, and wherein based at least in part on a query signal to the constellation and response signals from the constellation, the RFID reader is further configured to:
determine a distance from the RFID antenna to each RFID tag in the constellation;
determine a position of the RFID antenna to the reference RFID tag;
determine a lateral offset between the backboard and the RFID antenna; and
based on the determined distance and the determined position compensate for the determined lateral offset.

3. A medical device in accordance with claim 1, further comprising:
a backboard configured to be placed under the back of the patient, the backboard including the RFID tag as part of a constellation of RFID tags configured to transmit response signals in response to the query signal, in which based at least in part on one of the response signals from the constellation, the RFID reader is further configured to:
determine a distance from the RFID antenna to a selected back point in the constellation.

4. A medical device in accordance with claim 3, in which
the selected back point is one of the RFID tags determined to be the closest to the antenna.

5. A medical device in accordance with claim 3, in which
the selected back point is a point corresponding to substantially vertically derived footprint of the RFID antenna onto the backboard.
A medical device in accordance with claim 3, in which
at least some of the RFID tags in the constellation exhibit a regular, spatially periodic pattern.

6. A medical device in accordance with claim 5, in which
at least two of the RFID tags are configured to backscatter respective coordinates within the pattern.

7. A medical device in accordance with claim 1, wherein information on the RFID tag is locked, and the query signal includes a password for unlocking it.

8. A medical device in accordance with claim 1, wherein the RFID reader is further configured to determine the depth of CPR chest compression during delivery of at least one CPR chest compression based on a determination of a motion of the RFID antenna relative to the RFID tag using a Doppler effect between the query signal and the response signal.

9. A medical device in accordance with claim 1, wherein the RFID reader is further configured to determine the depth of CPR chest compression during delivery of at least one CPR chest compression based on a determination of a motion of the RFID antenna relative to the RFID tag using a phase shift between the query signal and the response signal.

10. A medical system comprising:
an external chest compressor that is configured to deliver the CPR compression between the front point and the back point; and
a medical device in accordance with claim 1.

11. A method that assists with delivery of cardiopulmonary resuscitation (CPR) compression to a patient by a medical device, the method comprising:
transmitting one or more query signals to a constellation of one or more RFID tags, the one or more RFID tags being in a fixed spatial relation with one of a front point that corresponds to a chest of the patient or a back point that corresponds to a back of the patient;
receiving one or more response signals from the constellation;
measuring the one or more response signals;
based at least in part upon the one or more measured response signals to the one or more query signals, inferring a depth of compression of a CPR compression between the front point and the back point; and
outputting an indication of the inferred depth of compression.

12. A method in accordance with claim 11 further comprises:
determining a distance from a RFID antenna to each of the one or more RFID tags of the constellation of a backboard, the constellation includes a reference RFID tag;
determining a position of the RFID antenna to the reference RFID tag;
determining a lateral offset between the backboard and the RFID antenna; and
based on the determined distance and determined position, compensating for the determined lateral offset.

13. A method in accordance with claim 11, wherein information on the RFID tag is encrypted.

14. A method in accordance with claim 11, wherein the one or more query signals include a password to unlock information locked on the RFID tag.

15. A method in accordance with claim 11, wherein the inferring of the depth of compression includes:
determining a motion of the constellation relative to a RFID antenna using a Doppler effect between the query signal and the one or more response signals.

16. A method in accordance with claim 11, wherein the inferring of the depth of compression includes:
determining a motion of the RFID tag relative to a RFID antenna using a phase shift between the query signal and the one or more response signals.

17. An article comprising: a storage medium, the storage medium having instructions stored thereon, wherein when the instructions are executed by at least one medical device configured that assists with delivery of cardiopulmonary resuscitation (CPR) to a patient, they result in:
transmitting a query signal to a RFID tag, the RFID tag being in a fixed spatial relation with one of a front point that corresponds to a chest of the patient or a back point that corresponds to a back of the patient;
receiving a response signal from the RFID tag;
measuring the response signal;
based at least in part upon the measured response signal to the query signal, inferring a depth of compression of a CPR compression between the front point and the back point based; and
outputting an indication of the inferred depth of compression.

18. An article in accordance with claim 177, wherein when the instructions are executed they result in:
determining a distance from a RFID antenna to each RFID tag in a constellation of RFID tags of a backboard, the constellation includes a reference RFID tag;
determining a position of the RFID antenna to the reference RFID tag;
determining a lateral offset between the backboard and the RFID antenna; and
based on the determined distance and determined position, compensating for the determined lateral offset.

19. An article in accordance with claim 17, wherein when the instructions of the inferring are executed they result in:
determining a motion of the RFID tag relative to a RFID antenna using a Doppler effect between the query signal and the response signal.

20. A method in accordance with claim 11, wherein when the instructions of the inferring are executed they result in:
determining a motion of the RFID tag relative to a RFID antenna using a phase shift between the query signal and the response signal.
